(19) United States
(12) Patent Application Publication
(10) Pub. No.: US 2017/0206608 A1
(43) Pub. Date: Jul. 20, 2017

(54) HORIZONTALLY-LINKED REINSURANCE NETWORK

(71) Applicant: Mark Smith, Mound, MN (US)

(72) Inventor: Mark Smith, Mound, MN (US)

(21) Appl. No.: 15/403,374

(22) Filed: Jan. 11, 2017

Related U.S. Application Data
(60) Provisional application No. 62/278,632, filed on Jan. 14, 2016.

(51) Int. Cl. G06Q 40/08; G06Q 40/00; G06Q 40/06

(52) U.S. Cl. CPC G06Q 40/08; G06Q 40/06; G06Q 40/10

(57) ABSTRACT

A Horizontally-Linked Reinsurance Network (HLRN) formed of a plurality of small insurance companies (as defined by applicable law, e.g. U.S.C. §831(b)) that is established and managed by a network administrator presents a new approach to harnessing the benefits of small insurance companies while mitigating the drawbacks of small insurance companies. This system uses a rules-based approach and algorithm to select, allocate, optimize and manage the individual risk portfolio of independent small insurance companies so as to preserve their status as a small insurance company while diversifying risk. Further, network administrator will perform the management functions if the HLRN. This allows investors or persons who would not otherwise own an insurance company to invest in a new asset class which by its nature demonstrates a non-correlation to traditional investment markets and carries both unique return and tax properties.

### CROSS REFERENCE TO RELATED APPLICATION

This application claims priority from United States Patent and Trademark Office Provisional Application No. 62/278,632 filed Jan. 14, 2016

### FIELD OF THE DISCLOSURE

This disclosure relates insurance. More specifically and without limitation, this disclosure relates to the establishment and operation of a horizontally-linked reinsurance network.

### BACKGROUND OF THE DISCLOSURE

Insurance is the equitable transfer of the risk of loss from one entity to another in exchange for a premium (e.g. money). It is a form of risk management primarily used to hedge against the risk of a contingent and uncertain loss. An insurer, or insurance carrier, is the party selling the insurance; the insured, or policyholder, is the person or entity that owns the risk of loss and therefore buys the insurance policy. The amount of money to be charged for an insurance policy is called the premium.

A typical insurance transaction involves the insured assuming a guaranteed and known relatively small loss in the form of payment to the insurer in exchange for the insurer's promise to compensate (indemnify) the insured in the case of a financial (personal) loss. The insured receives a contract, called the insurance policy, which details the conditions and circumstances under which the insured will be financially compensated.

Common forms of insurance include automobile insurance, home owner's insurance, health insurance, life insurance, some types of crop insurance, among other forms of insurance. These forms of insurance are offered by a great number insurance providers, insurance companies, writing insurance companies or otherwise known as “fronting insurance companies.” Well-known companies that offer these forms of insurance include: State Farm, Allstate, Liberty Mutual, Berkshire Hathaway, Travelers, AIG, Nationwide, Progressive, Farmers, USAA, Hartford, Chubb, American Family and Allianz, among many others.

These common forms of insurance are, from an insurance standpoint, relatively high probability and relatively low risk for the fronting insurance company. That is, the chances of a claim occurring are high, but when a claim occurs the loss is generally low. Due to the great number of these common insurance policies that are written, the fronting insurance companies have a high level of understanding as to the risk of loss and therefore a high level of understanding as to how to price the policy to the insured, as well as the ability to spread the risk of loss across a great number of policies. As such, consumers seeking these common forms of insurance have a great number of coverage options by a great number of providers at generally competitive prices. For these reasons, most persons and businesses have insurance coverage for these common forms of high probability and low risk events.

Unfortunately, many persons and companies have areas of great exposure that are not covered or not coverable by common forms of insurance. In addition, to limit the fronting insurance company's exposure, these common insurance policies tend to include a great number of exclusions as well as a cap to the maximum recoverable amount. Many of these uncovered risks or events have a relatively or extremely low probability of occurring, but if they do occur they have a relatively or extremely high amount of loss. Therefore, if these uncovered losses occur, they have a substantial impact on the person or company.

Examples of these often uncovered types of risk include: career ending injuries to a professional athletes, injury to the appearance of an actor or model that prevents them from working, injury to a performer that prevents them from performing, animal mortality due to various diseases for animal producers, risk of loss due to terrorism events, oil spills, chemical or nuclear contamination or the like, among countless other events.

The owners of these forms of low probability but catastrophic risk tend to find it difficult, if not impossible, to secure coverage for these areas of low probability but catastrophic risk. This is often because insurance companies have tremendous difficulty calculating the potential, or actuarial, risk of loss based on the unique facts applicable to each potential insurance policy. In addition, the generally high amount at risk for the fronting insurance companies is generally unappealing. As such, most insurance companies tend to shy away from writing these low probability but high risk policies. This is especially true when the insurance policies cover a somewhat unusual risk event.

Even if a risk owner is able to find an insurance company willing to offer coverage for these unusual low probability but catastrophic risks, because few insurance companies will even consider offering these forms of coverage, the premiums tend to be prohibitively expensive. As such, many risk owners go without insurance coverage knowing that they could lose everything in the, albeit unlikely, event that an uncovered catastrophic event occurs.

In an attempt to help risk owners secure insurance coverage for these low probability but catastrophic areas of risk Congress enacted the 26 US Code §831 that provides special tax benefits to what are statutorily defined “Small Insurance Companies” to aid their formation. That is, §831 provides tax benefits to small insurance companies so as to encourage the formation of these entities in hopes that these small insurance companies will provide alternatives to, and a more-competitive marketplace for, various forms of insurance.

The recently revised §831, which will become effective in 2017, is as follows:

§831 Tax on insurance companies other than life insurance companies.
(a) General rule.
Taxes computed as provided in section 11 shall be imposed for each taxable year on the taxable income of every insurance company other than a life insurance company.
(b) Alternative tax for certain small companies.
   (1) In general. In lieu of the tax otherwise applicable under subsection (a), there is hereby imposed for each taxable year on the income of every insurance company to which this subsection applies a tax computed by multiplying the taxable investment income of such company for such taxable year by the rates provided in section 11(b).
   (2) Companies to which this subsection applies.
      (A) In general. This subsection shall apply to every insurance company other than life if—
         (i) the net written premiums (or, if greater, direct written premiums) for the taxable year do not exceed $2,200,000,
         (ii) such company meets the diversification requirements of subparagraph (B), and
         (iii) such company elects the application of this subsection for such taxable year.
      The election under clause (iii) shall apply to the taxable year for which made and for all subsequent taxable years for which the requirements of clauses (i) and (ii) are met. Such an election, once made, may be revoked only with the consent of the Secretary.
      (B) Diversification requirements.
         (i) In general. An insurance company meets the requirements of this subparagraph if—
         (I) no more than 20 percent of the net written premiums (or, if greater, direct written premiums) of such company for the taxable year is attributable to any one policyholder, or
         (II) such insurance company does not meet the requirement of subclause (I) and no person who holds (directly or indirectly) an interest in such insurance company is a specified holder who holds (directly or indirectly) aggregate interests in such insurance company which constitute a percentage of the entire interests in such insurance company which is more than a de minimis percentage higher than the percentage of interests in the specified assets with respect to such insurance company held (directly or indirectly) by such specified holder.
         (ii) Definitions. For purposes of clause (i)(II) —
         (I) Specified holder. The term “specified holder” means, with respect to any insurance company, any individual who holds (directly or indirectly) an interest in such insurance company and who is a spouse or lineal descendant (including by adoption) of an individual who holds an interest (directly or indirectly) in the specified assets with respect to such insurance company.
         (II) Specified assets. The term “specified assets” means, with respect to any insurance company, the trades or businesses, rights, or assets with respect to which the net written premiums (or direct written premiums) of such insurance company are paid.
         (III) Indirect interest. An indirect interest includes any interest held through a trust, estate, partnership, or corporation.
         (IV) De minimis. Except as otherwise provided by the Secretary in regulations or other guidance, 2 percentage points or less shall be treated as de minimis.
      (C) Controlled group rules.
         (i) In general. For purposes of this paragraph —
         (I) In determining whether any company is described in clause (i) of subparagraph (A), such company shall be treated as receiving during the taxable year amounts described in such clause (i) which are received during such year by all other companies which are members of the same controlled group as the insurance company for which the determination is being made and
         (II) in determining the attribution of premiums to any policyholder under subparagraph (B)(i), all policyholders which are related (within the meaning of section 267(b) or 707(b)) or are members of the same controlled group shall be treated as one policyholder.
         (ii) Controlled group. For purposes of clause (i), the term “controlled group” means any controlled group of corporations (as defined in section 1563(a); except that—
         (I) “more than 50 percent” shall be substituted for “at least 80 percent” each place it appears in section 1563(a), and
         (II) subsections (a)(4) and (b)(2)(D) of section 1563 shall not apply.
      (D) Inflation adjustment. In the case of any taxable year beginning in a calendar year after 2015, the dollar amount set forth in subparagraph (A)(i) shall be increased by an amount equal to—
         (i) such dollar amount, multiplied by
         (ii) the cost-of-living adjustment determined under section 1(f)(3) for such calendar year by substituting “calendar year 2013” for “calendar year 1992” in subparagraph (B) thereof.
      If the amount as adjusted under the preceding sentence is not a multiple of $50,000, such amount shall be rounded to the next lowest multiple of $50,000.
   (3) Limitation on use of net operating losses.
   For purposes of this part, except as provided in section 844, a net operating loss (as defined in section 172) shall not be carried—
      (A) to or from any taxable year for which the insurance company is not subject to the tax imposed by subsection (a), or
      (B) to any taxable year if, between the taxable year from which such loss is being carried and such taxable year, there is an intervening taxable year for which the insurance company was not subject to the tax imposed by subsection (a).
(c) Insurance company defined.
For purposes of this section, the term “insurance company” has the meaning given to such term by section 816(a).
(d) Reporting.
Every insurance company for which an election is in effect under subsection (b) for any taxable year shall furnish to the Secretary at such time and in such manner as the Secretary shall prescribe such information for such taxable year as the Secretary shall require with respect to the requirements of subsection (b)(2)(A)(ii).
(e) Cross references.
   (1) For alternative tax in case of capital gains, see section 1201(a).
   (2) For taxation of foreign corporations carrying on an insurance business within the United States, see section 842.
   (3) For exemption from tax for certain insurance companies other than life, see section 501(c)(15).

While §831 certainly promotes the formation of small insurance companies by providing substantial tax benefits to these companies, these small insurance companies still suffer from many disadvantages. Namely, due to the strict limits and requirements placed upon these small insurance companies their applicability is somewhat restrained or limited. Furthermore, the reason why so many insurance companies are so large (other than the fact that insurance can be a very profitable business) is because insurance companies tend to benefit when the risk of loss on any one policy is diluted by having a great number of policies. However, due to the net premium limitations place upon small insurance companies by §831 small insurance companies are statutorily limited from spreading their risk of loss across an unlimited number insurance policies. In addition, due to their small size, the administration and operation costs for a stand-alone small insurance company can be undesirably, if not prohibitively, high. For these reasons, among many others, the use of small insurance companies, and therefore their proliferation, has been limited.

Thus, it is a primary object of the disclosure to provide a horizontally-linked reinsurance network that improves upon the state of the art and helps to facilitate the use of small insurance companies.

Another object of the disclosure is to provide a horizontally-linked reinsurance network that harnesses the tax benefits available to small insurance companies.

Yet another object of the disclosure is to provide a horizontally-linked reinsurance network that diversifies the risk of loss for a small insurance company.

Another object of the disclosure is to provide a horizontally-linked reinsurance network that links a plurality of small insurance companies together so that they may benefit from size and diversity, while preserving their status as a small insurance company.

Yet another object of the disclosure is to provide a horizontally-linked reinsurance network that is easy to administer.

Another object of the disclosure is to provide a horizontally-linked reinsurance network that is easy to use as a consumer.

Yet another object of the disclosure is to provide a horizontally-linked reinsurance network that increases consumer access to unusual or obscure forms of insurance.

Another object of the disclosure is to provide a horizontally-linked reinsurance network that reduces the administration cost for a small insurance company.

Yet another object of the disclosure is to provide a horizontally-linked reinsurance network that reduces the operation cost for a small insurance company.

Another object of the disclosure is to provide a horizontally-linked reinsurance network that reduces the risk to the consumer that a claim goes unpaid due to a small insurance company failing or going bankrupt.

Yet another object of the disclosure is to provide a horizontally-linked reinsurance network that improves consumer confidence in the use of small insurance companies.

Another object of the disclosure is to provide a horizontally-linked reinsurance network that spreads the risk of loss across a plurality of small insurance companies.

Yet another object of the disclosure is to provide a horizontally-linked reinsurance network that spreads the risk of recovery across a plurality of small insurance companies.

Another object of the disclosure is to provide a horizontally-linked reinsurance network that makes it easier for new small insurance companies to form and operate.

Yet another object of the disclosure is to provide a horizontally-linked reinsurance network that allows for easy payment of claims across a plurality of small insurance companies.

Another object of the disclosure is to provide a horizontally-linked reinsurance network that creates a new investable asset class never before available that provides preferable tax attributes, appealing returns, and non-correlation to many other asset classes.

Yet another object of the disclosure is to provide a horizontally-linked reinsurance network that allows small insurance companies to participate in the benefits of scale and mass.

Another object of the disclosure is to provide a horizontally-linked reinsurance network that makes owning an insurance company a possibility for persons that would not otherwise be capable of owning an insurance company.

Yet another object of the disclosure is to provide a horizontally-linked reinsurance network that allows small insurance companies to operate in a more efficient manner.

Another object of the disclosure is to provide a horizontally-linked reinsurance network that complies with the spirit and scope of the laws relating to small insurance companies.

Yet another object of the disclosure is to provide a horizontally-linked reinsurance network that allows small insurance companies to operate in a more disciplined manner.

Another object of the disclosure is to provide a horizontally-linked reinsurance network that allows small insurance companies to operate in a more consistent manner.

Yet another object of the disclosure is to provide a horizontally-linked reinsurance network that allows a plurality of small insurance companies to take on risk collectively that would exceed the statutory limits placed upon a single small insurance company.

Another object of the disclosure is to provide a horizontally-linked reinsurance network that makes it more desirable to own and operate a small insurance company.

Yet another object of the disclosure is to provide a horizontally-linked reinsurance network that makes it more desirable to use a small insurance company.

Another object of the disclosure is to provide a horizontally-linked reinsurance network that allows a small insurance company to have a broadly diversified risk portfolio.

Yet another object of the disclosure is to provide a horizontally-linked reinsurance network that allows a small insurance company to have a geographically diversified risk portfolio.

Another object of the disclosure is to provide a horizontally-linked reinsurance network that employs algorithms to diversify the risk among a plurality of small insurance companies.

Yet another object of the disclosure is to provide a horizontally-linked reinsurance network that allows for the purchase of reinsurance to limit the risk of loss for any one small insurance company.

Another object of the disclosure is to provide a horizontally-linked reinsurance network that allows for the investment of insurance premiums.

Yet another object of the disclosure is to provide a horizontally-linked reinsurance network that efficiently provides reports and audit information regarding the operation.

These and countless other objects, features, or advantages of the disclosure will become apparent from the specification, claims and drawings.

### SUMMARY OF THE DISCLOSURE

A Horizontally-Linked Reinsurance Network (HLRN) formed of a plurality of small insurance companies (as defined by applicable law, e.g. U.S.C. §831(b)) that is established and managed by a network administrator presents a new approach to harnessing the benefits of small insurance companies while mitigating the drawbacks of small insurance companies. This system uses a rules-based approach and algorithm to select, allocate, optimize and manage the individual risk portfolio of independent small insurance companies so as to preserve their status as a small insurance company while diversifying risk. Further, network administrator will perform the management functions if the HLRN. This allows investors or persons who would not otherwise own an insurance company to invest in a new asset class which by its nature demonstrates a non-correlation to traditional investment markets and carries both unique return and tax properties.

### BRIEF DESCRIPTION OF THE DRAWINGS

FIG. 1 is a plan view of a horizontally linked insurance network;

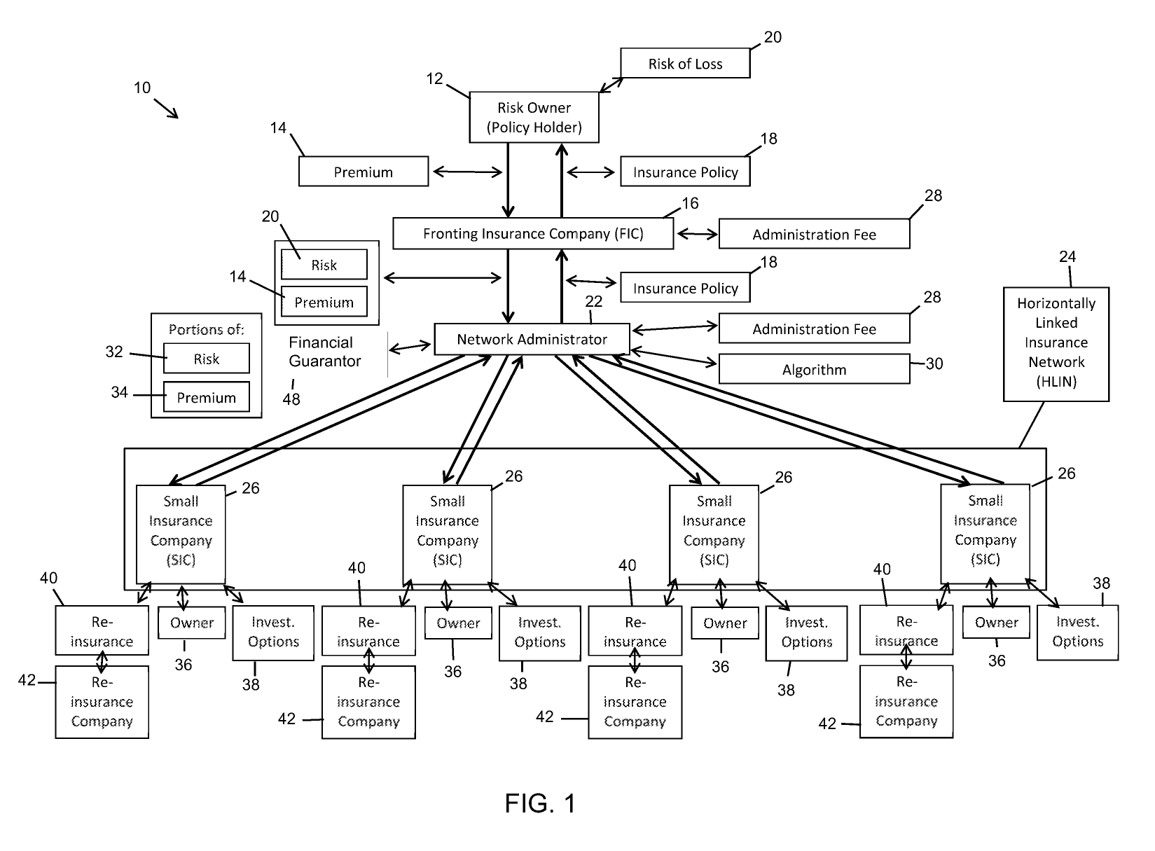

FIG. 2 is a plan view of a horizontally linked insurance network

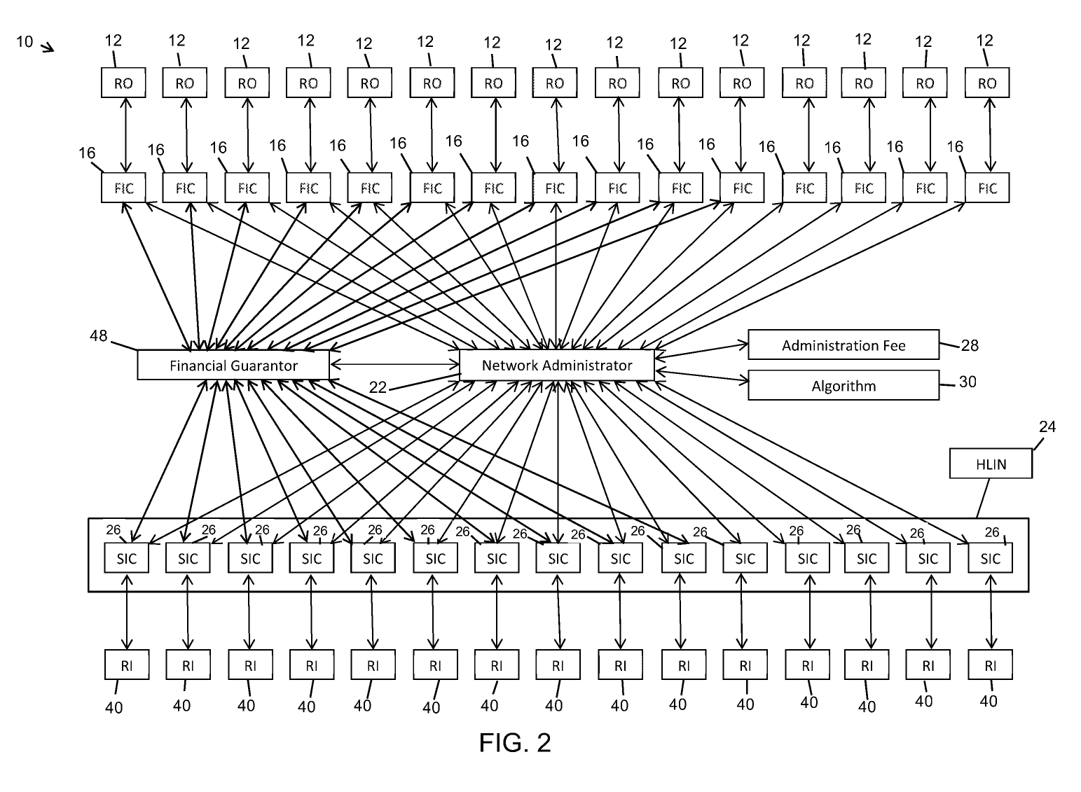

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure (s). The following detailed description is, therefore, not to be taken in a limiting sense, and the scope of the disclosure (s) is defined only by the appended claims, along with the full scope of equivalents to which such claims are entitled.

With reference to the figures, an insurance system 10 (or system 10) and method of operation is presented. The system 10 includes a plurality of risk owners 12 that pay a premium 14 to a fronting insurance company 16 to receive an insurance policy 18 to cover a risk of loss 20 owned by the risk owner 12. Once the insurance policy 18 is written by the fronting insurance company 16 and provided to the risk owner 12, the risk owner 12 becomes the policy holder 12. That is, the risk owner and policy holder are one and the same once the policy is written, accepted and paid for.

Once the insurance policy 18 is written, the fronting insurance company 16 has several options as to how handle the insurance policy 18. The fronting insurance company 16 can of course maintain the insurance policy 18 themselves and assume the risk of loss 20 and retain the premium 14. Alternatively, in this example, the fronting insurance company 16 submits the insurance policy 18 to the network administrator 22 for distribution across the horizontally-linked reinsurance network 24 (HLRN 24) formed of a plurality of small insurance companies 26.

More specifically, the fronting insurance company 16 transmits the risk of loss 20 and the premium 16 to the network administrator 22, while retaining an administration fee 28. The administration fee 28 provides compensation for the costs incurred by the fronting insurance company 16 for customer service, account administration, making contact with the risk owner, among countless other costs incurred and services provided by the fronting insurance company 16.

Upon receiving the risk of loss 20 and premium 14 from the fronting insurance company 16 the network administrator 22 analyzes the risk of loss 20 which may include and using an algorithm 30. If accepted, the risk of loss 20 (and corresponding premium 14) for insurance policy 18 is divided into portions of risk 32 (and corresponding portions of premium 34) which are distributed among the small insurance companies 26 while taking care to ensure that any one small insurance company 26 does not violate the statutory requirements of being a small insurance company pursuant to §831 or any other applicable statute, law, rule or guideline. It is contemplated that what a small insurance company 26 is will shift and change from time to time as the laws, statutes and regulations change.

The network administrator 22 retains an administration fee 28 from the premium 14 for these services. The administration fee 28 provides compensation for the costs incurred by the network administrator 22 for servicing the fronting insurance companies 16, account administration, network administration, among countless other costs incurred and services provided by the network administrator 22.

The small insurance companies 26, which are owned by one or more owners 36, retain the allocated portions of premium 34 (while providing coverage for the allocated portions of risk 32) during the term of the insurance policy 18, or for any other statutorily required period of time. Network administrator 22 provides a plurality of investment options 38 for investment of the allocated portions of premium 34. These allocated portions of premium 34 are invested on behalf of the owners 36 of the small insurance company 26 at their direction (that is the owners 36 choose how the funds are invested among the disclosure options 38 provided by the network administrator 22) or alternatively without their direction (that is the network administrator 22 chooses how to invest the funds without the direction of the owners 36). In one arrangement, the network administrator 22 receives an investment administration fee 28 for providing these investment options 38; whereas in other arrangements the fees for managing the investments are included in the overall administration fee 28. Alternatively, the network administrator 22 receives a kickback for selecting and/or investing funds in the various investment options 38 from the operators of the investment options 38. Any other form of compensation is hereby contemplated for management of the investments on behalf of the owner(s) 36.

In one arrangement, to reduce the amount of risk incurred by any one small insurance company 26, network administrator 22 (and/or the owner(s) 36 of the small insurance company 26) may arrange for reinsurance 40 provided by a reinsurance company 42. Reinsurance 40 is any form of insurance to cover the risk of loss on the portions of risk 32 assumed by the small insurance company 26 from the insurance policies 18. In one arrangement, network administrator 22 receives an administration fee 28 for arranging the reinsurance 40 for the small insurance company 26, whereas in other arrangements the network administrator 22 receives a kickback or other compensation from the reinsurance company 42.

When a policy holder 12 experiences a loss 44 covered by the insurance policy 18 they submit a claim 46 to the fronting insurance company 16 that wrote the insurance policy 18. The fronting insurance company 16 investigates the alleged loss and if the fronting insurance company 16 verifies a loss did in fact occur, the fronting insurance company 16 submits the claim 46 to the network administrator 22. The network administrator 22 retrieves funds for payment of the claim from the small insurance companies 26 that received the portions of risk 32 that were called. The network administrator 22 retrieves these funds in the proportion and in the order allocated. The network administrator 22 can retrieve these funds from cash held within the small insurance company 26, by liquidating investments made through the investment options 38 offered to the small insurance company, and/or by recovering from the reinsurance company 42 if reinsurance 40 was purchased on behalf of the small insurance company 26.

Once the funds are retrieved by the network administrator 22, the funds are transmitted to the fronting insurance company 16. Once the fronting insurance company 16 receives the funds, the funds are transmitted to the policy holder 12 in compensation for their loss.

Risk Owner:

More specifically, the risk owner 12 is any person, company, group or entity that has any risk exposure that is not covered by conventional or common insurance policies. Examples include:
career ending, or career suspending injury to professional athletes;
injury to the appearance of an actor or model that causes them to not be employed;
injury to the voice of professional singers;
environmental risks to the owners of vacation properties or attractions, such as oil spills, chemical spills, nuclear contamination or the like;
risk of animal mortality, various infections or diseases that make animals unsellable for animal producers;
various risks to crops or cropland for farmers, such as fires to crops in the field, salt water contamination, severe erosion, or any other not-covered risk;
risks due to terrorism or terroristic acts.
   A risk owner 12 can itself be an insurance company or a reinsurance company. These are only a few of countless other examples of such risk.

Premium:

More specifically, the premium 14 is the amount paid by the risk owner 12 in return for passing the risk of loss off to the fronting insurance company 16 for the insurance policy 18. The premium 14 can be any amount agreed upon by and between the risk owner 12 and the fronting insurance company 16. The premium may be paid by one lump sum, or though installments during the term of the insurance policy 18, or in any other manner.

Fronting Insurance Company:

More specifically, the fronting insurance company 16 is any company that interfaces with the risk owner 12 and writes the insurance policy 18 to the risk owner 12 (who then becomes the policy owner 12). Well-known insurance companies that can serve as fronting insurance companies 16 include: State Farm, Allstate, Liberty Mutual, Berkshire Hathaway, Travelers, AIG, Nationwide, Progressive, Farmers, USAA, Hartford, Chubb, American Family and Allianz, among many others. Fronting insurance companies 16 write the insurance policies 18 using their policy language, forms and expertise. Fronting insurance companies 16 also use their established network of sales persons and customer service persons to make contact with the risk owners 12, sell the insurance policies 18 and provide customer service to the policy holders 12.

Many fronting insurance companies 16 have nationwide footprints and therefore have the ability to submit insurance policies 18 to the HLRN 24 that underwrite risk across the country. This is beneficial as it is desirable to spread the risk of loss across disparate geographies. This is because loss events tend to be limited in their geographic scope. That is, an earthquake in California tends not to effect the rest of the country; a flood along the Mississippi River Delta tends not to effect the rest of the country; a terroristic act in New York tends not to effect the rest of the country; a fire in the western states tends not to affect the rest of the country; a drastic economic downturn in Michigan tends not to affect the rest of the country; and so on. As such, these nationwide fronting insurance companies 16 have their own built-in geographic diversification. The concentration of risks can be further diluted by working with a plurality of nationwide fronting insurance companies 16.

On the other hand, many fronting insurance companies 16 have regional footprints, and therefore these regional fronting insurance companies 16 tend to have an undesirably high risk of loss concentrated in a geographic area or region. As an example, a regional fronting insurance company 16 that operates exclusively in Iowa is likely to have a statistically skewed risk of loss to events that occur in Iowa, such as droughts, floods, economic downturns, chemical spills, governmental shutdowns, etc. While this geographic concentration of risk is undesirable for the regional fronting insurance company 16 itself, by receiving insurance policies 18 into the HLRN 24 from a plurality of regional fronting insurance companies 16 allows the HLRN 24 to geographically diversify the risk within the small insurance company 26 which is a benefit.

To be clear, fronting insurance company 16 can itself be a reinsurance company, in which case the risk owner 12 is an insurance company (who is itself providing insurance to risk owners).

Insurance Policy:

More specifically, the insurance policy 18 is the contractual agreement between the risk owner 12 and the fronting insurance company 16. The insurance policy 18 defines what is covered and what is not covered, the amounts of coverage, the limits of coverage, any excluding factors, the term of coverage, the manner in which a claim is submitted, the reasons for which a claim may be denied, the amount of the premium 14 and the terms for payment, among other elements of the agreement. The insurance policy 18 may, or may not, include a provision allowing for submission of the insurance policy 18 to the HLRN 24.

Risk of Loss:

More specifically, the risk of loss 12 is any event that causes loss or damage to the risk owner 12. When coverage is sought to protect against the damage caused to the risk owner 12 in the event that the risk of loss 20 occurs, the risk of loss 20 is defined as a covered event in the insurance policy 18.

Network Administrator:

More specifically, the network administrator 22 is the entity, person, company or group that establishes and operates the horizontally-linked reinsurance network 24 of small insurance companies 26. In one arrangement, the network administrator 22 facilitates all needs of the horizontally-linked reinsurance network 24.

The network administrator 22 recruits the fronting insurance companies 16 to submit insurance policies 18 to the HLRN 24 and trains the fronting insurance companies 16 how to write acceptable insurance policies 18 that can be submitted to the HLRN 24. In addition, the network administrator 22 promotes the benefits of the HLRN 24 to potential fronting insurance companies 16 which is beneficial to the HLRN 24 as the higher the number of insurance policies 18 submitted to the HLRN 24 the greater the diversification.

The network administrator 22 establishes the rules of operation of the HLRN 24. That is, what the guidelines are for acceptable insurance policies 18; the manner of operation of the HLRN 24, how claims 46 are submitted; how portions of premium 34 and portions of risk 32 are distributed across the small insurance companies 26; the amounts charged for the administration fees 28, how the small insurance companies 26 are to operate, etc.

The network administrator 22 receives, reviews and evaluates the insurance policies 18 submitted to the HLRN 24. The network administrator 22 serves as the gatekeeper and determines whether specific insurance policies 18 meet the needed criteria and therefore are acceptable into the HLRN 24.

Similarly, the network administrator 22 receives, reviews and evaluates the claims 46 submitted by the fronting insurance companies 16. The network administrator 22 serves as the gatekeeper for whether a claim 46 should be paid.

The network administrator 22 also establishes the rules for allocation of portions of risk 32 (and portions of premium 34) among the small insurance companies 26. This includes reviewing the applicable laws, rules, statutes and guidelines and establishing rules for allocation of portions of risk 32 (and portions of premium 34) among the small insurance companies 26 in the HLRN 24, which includes the development, and revision of algorithm 30, as is further described herein. The term “algorithm” herein is to be broadly construed and includes rules, guidelines, as well as any software or computer executed code that is used to distribute portions of risk 32 and portions of premium 34 among the small insurance companies 26 that are part of the HLRN 24.

Horizontally-linked Reinsurance Network:

More specifically, the HLRN 24 includes the plurality of small insurance companies 26 that are connected to one another through network administrator 22. The small insurance companies 26 of the HLRN 24 are autonomous from one another, however they are linked together by the network administrator 22 which distributes portions of risk 32 and portions of premium 34 across the plurality. While the small insurance companies 26 are autonomous, the network administrator 22 distributes the portion of risk 32 and the portion of premium 34 to the small insurance companies 26 and withdraws the funds to pay approved claims 46 from the small insurance companies 26.

Small Insurance Companies:

More specifically, small insurance companies 26 are those that comply with applicable rules, laws, statues and other administrative guidelines to qualify as for the tax beneficial status of being a small insurance company. To qualify as a small insurance company, the small insurance companies 26 are required to take volitional acts, such as affirmatively request the status, partake in audits, among other requirements. To qualify as a small insurance company, the small insurance companies 26 are required to not take certain volitional actions, such as have familial risk, have too much risk from a single entity, exceed a maximum premium amount, among other requirements.

Algorithm:

More specifically, the term “algorithm” 30 herein is to be broadly construed and includes any rules or guidelines that are used to select which insurance policies 18 are accepted into the HLRN 24 and how to distribute portions of risk 32 (and portions of premium 34) among the small insurance companies 26 that are part of the HLRN 24, as well as any software or computer executed code that is used to distribute portions of risk 32 and portions of premium 34 among the small insurance companies 26 that are part of the HLRN 24. While the term algorithm 30 may imply a software program, macro or computer executable code, the term as used herein is not exclusively limited to just computer executable code or software. Instead, the term algorithm 30, while it may include computer executable code or software that performs sophisticated calculations, the term algorithm 30 also includes simple guidelines which can be employed without sophisticated computer executable code or software. As such, the term algorithm 30 as is used herein includes any rules, guidelines, computer executable code or software or other systems or methods used by the network administrator 22 to allocate portions of risk 32 among the small insurance companies 26.

In one arrangement, the algorithm 30 is computer-generated risk analysis and allocation methodology program that efficiently analyzes and allocates risk 20 among multiple small insurance companies 26 which are part of the HLRN 24 (instead of consolidating risk in large insurance companies that are increasingly “too big to fail”). Insurance policies 18 written by the fronting insurance companies 16 are analyzed to consider the following risk attributes:
(a) Fronting insurance company 16.
(b) Underlying risk owner (policy holder) 12.
(c) Taxpayer ID of risk owner (policy holder) 12.
(d) Mortgage holder (if applicable).
(e) Type of risk being insured.
(f) Perils being insured.
(g) Payment terms of risk.
(h) Dates of coverage.
(i) Geographic location of risk.
(j) Aggregate value of total risk.
(k) Aggregate premium for reinsurance 40.
(l) Policy claim information.
(m) Priority position in loss chain.
(n) Other proprietary factors.
(o) Any other applicable factor.

The risk attributes of the collective “macro pool” of risk 20 available from the aggregate insurance policies 18 submitted to the HLRN 24 by the fronting insurance companies 16 is allocated across the network of small insurance companies 26 that are part of the HLRN 22.

During this allocation the following “micro constraints”, which are unique for each small insurance company 26, shall be observed (so as to not disqualify a small insurance company 26 from qualifying as a small insurance company under applicable law):
(p) Company Name.
(q) Company owner.
(r) Taxpayer ID number.
(s) Individual small insurance company statutory premium constraint.
(t) Individual small insurance company financial premium constraint.
(u) Individual small insurance company capitalization constraint.
(v) Insurance risk constraint:
   1. Listing of restricted insureds.
   2. Prevention of intra-family or intra-operation risk.
(w) Risk portfolio control restraints:
   1. Maximum risk exposure to any one policyholder(s).
   2. Maximum risk exposure to any one peril, industry, or species, or geography.
(x) Reinsurance risk cutout level.
(y) Investment management information:
   1. Individual investment manager selection.
   2. Model investment portfolio indicator(s).
   3. Percentage allocation election for both reserves & surplus.
      i. (Investment manager %, model portfolio(s) % for both reserves & surplus).
(z) Other proprietary factors
(aa) Any other applicable factors

The algorithm 30 utilizes the risk attributes from the “macro pool” while operating within the “micro constraints” for the individual small insurance companies 26 that are part of the HLRN 24. In addition to considering the “macro pool” and the “micro constraints” the algorithm 30 also considers the following characteristics when allocating risk among the member small insurance companies 26 participating in the HLRN 24:
(a) Macro small insurance company risk portfolio design (specific across the HLRN 24):
   a. Desired level of value at risk range.
   b. Uniformity of risk among members of HLRN 24.
   c. Other proprietary factors.
(b) Statistical data samples:
   a. Insurance risk experience.
   b. Risk management principles.
   c. Financial inputs.
   d. Investment experience.
   e. Other proprietary factors.

The network administrator 22 ultimately allocates portions of risk 32 from insurance policies 18 among the various member small insurance companies 26 of the HLRN 24 based on the results of the algorithm 30. The analysis available from the algorithm 30 also provides the following data:
(a) Selector report containing a series risk portfolios for the member small insurance companies 26:
   a. Report will include statistics:
      i. Fit conformance for each specific small insurance company 26.
      ii. Macro network fit conformance.
(b) Each risk within each portfolio will contain a unique number identifier
   a. Identifier ID will contain:
      i. Parameters of the underlying risk.
(c) Fronting insurance company report:
   a. Cross selection of macro risk reinsurance assignment across all small insurance company(s) 42.
(d) Investment portfolio management report:
   a. Demonstrating the summary effects of the various investment decisions.
(e) Annual insurance commissioner domicile report preparations:
   a. Financial audit.
   b. Actuarial certification.

Once the initial allocation is established, the algorithm 30 may be employed to refine and improve the risk allocation to the small insurance companies 26 though:
(a) Continual system processes
   a. Refinement of risk portfolios.
   b. Shifting of policy allocations.

These reallocations of risk can occur on any timeframe such as continuously, daily, weekly, monthly, quarterly, yearly, at the close of an insurance policy 18 term, or on any other basis. In this way, the system 10, and use of the algorithm 30 may be used to continually balance and reallocate risk among a plurality of small insurance companies 26 so that the small insurance companies 26 within a HILN 24 may share in or experience the best possible diversification.

As a further step, the algorithm 30 takes into account the bulk risks of the HLRN 24. The algorithm 30 includes a series of sub routines that culminates into a looping iterative process to buildout the risk portfolio of the individual small insurance companies 26.

The sub routines may include:
(a) Calculates the risk properties of each individual risk.
(b) Measures the historic corollary movements and interdependencies of all the risks.
(c) Develops individual constraints to be applied to each Small insurance company.
(d) Develops the macro network level allocation restrictions and optimal goals of the process.
(e) Initiates an iterative process of randomly allocating risks to each Small insurance company.
   a. First choice of process is to proportionally allocate risks amongst Small Insurance Companies.
   b. Second choice of the process is to actuarially slice and distribute risks amongst Small Insurance Companies.
   c. A combination of risk allocation tactics would typically be required to accomplish the optimization goals for the network.
(f) Refine and reallocate small insurance company risk portfolios until macro network optimization goals are met.
(g) Iteration process ceases operation after an efficiency quotient of optimization goals is met.
(h) Unique serial numbers are given to each individual risk in every Small insurance company.
(i) Insurance policies are issued to the policyholders articulating the manner and magnitude their risk(s) are covered by the given Small insurance company.
(j) Premiums are collected and allocated in a manner consistent with risk allocation methodology of the network.

Above is an example of one form of algorithm 30, or factors that are considered by one algorithm 30. Any other information may be considered or not considered as part of algorithm 30.

As is evident from the above, algorithm 30 is used to simultaneously consider the unique properties and constraints of the small insurance companies 26 that are part of the HLRN 24 while simultaneously considering the unique properties of the insurance policies 18 that are accepted into the HLRN 24. While simultaneously considering the properties of some or all of the small insurance companies 26 and the properties of some or all of the insurance policies 18, the algorithm 30 slices up or divides and distributes the risk of loss 20 (and the premium 14) among some or all of the small insurance companies 26 which are part of the HLRN 24.

Algorithm 30 may be used to distribute the portions of risk 32 (and portions of premium 34) across the small insurance companies 26 such that the small insurance companies 26 have approximately equal risk profiles (exposure) and premiums held within the companies.

Portion of Risk:

More specifically, when an insurance policy 18 is accepted by network administrator 22 into the HLRN 24, it is likely that it is best to slice up the risk of loss 20 and distribute these individual slices, parts or pieces of risk among a plurality of small insurance companies 26. This divides the risk across a number of small insurance companies 26 and therefor allows a small insurance company 26 to hold a greater number of insurance policies 18 within the company without running afoul of the restrictions bestowed upon small insurance companies 26. This allows a small insurance company 26 to benefit from greater diversification (which is one of the greatest drawbacks for a small insurance company 26) while partaking in the tax benefits of being a small insurance company 26 (which is one of the greatest benefits for a small insurance company 26).

The portion of risk 32 is the slice, part or piece of risk that is distributed to a small insurance company 26. The risk of loss 20 associated with an insurance policy 18 may be divided in any manner.

As one example, the risk of loss 20 may be divided into a number of equal pieces, each one bearing an equal amount or percentage of the total risk. In this example, each small insurance company 26 that receives a piece of this risk stands in equal footing to one another. That is, if a claim 46 is submitted and paid, the owner of each portion of risk 32 pays an equivalent amount. As an example, if an insurance policy 18 is written for an animal producer, and ten percent of their animals die, each small insurance company pays an equal amount to compensate the policy holder 12 for their loss.

As another example, the risk of loss 20 may be divided into unequal pieces, each one bearing a dissimilar amount of risk. In this example, each small insurance company 26 that receives a piece of this risk stands in unequal footing to one another. As an example, if an insurance policy 18 is written for an animal producer, and each portion of risk 32 is for five percent of the animals in order, and ten percent of their animals die, the small insurance companies 26 that are allocated the risk of loss 20 for the first five percent of animal mortality, and the second five percent of animal mortality, are required to compensate the policy holder 12, while the other small insurance companies 26 that hold the portions of risk 32 for the third through twentieth slices of risk do not pay anything.

These are merely examples of how the risk of loss 20 can be separated into pieces so that and these portions of risk 32 may be distributed in an equal fashion, or an unequal fashion, across a plurality of small insurance companies 26 to render a generally equal or generally unequal overall risk portfolio within the small insurance companies 26, as is desired.

Portion of Premium:

More specifically, and similar to the above, when an insurance policy 18 is accepted by network administrator 22 into the HLRN 24, it is likely that it is best to slice up the risk of loss 20 and distribute these individual slices, parts or pieces of the risk of loss 20 among a plurality of small insurance companies 26 for purposes of diversification. Similarly, the premium 14 is distributed among the small insurance companies 26. The premiums 14 from the insurance policies 18 accepted into the HLRN 24 may be divided among the small insurance companies 26 in any manner necessary to accomplish the goals of the owners 26 of the small insurance companies 26 and/or the network administrator 22.

As one example, in a HLRN 24 where the goal is to allocate an approximately equal risk profile across all small insurance companies 26, it may be desirable to aggregate the premiums 14 and distribute them equally across all small insurance companies 26 which are part of the HLRN 22.

As another example, where the risk of loss 20 is divided into unequal pieces, each one bearing a dissimilar amount of risk, it may be desirable to assign a portion of premium 34 to each unequal portion of risk 32. Following the above example, where animal mortality risk is separated into five percent slices, the portion of premium 34 associated with receiving the portion of risk 32 for the first five percent of animal mortality is substantially greater (because it has a substantially higher risk of being claimed) than the portion of risk 32 for the last five percent of animal mortality (because it has a substantially lower risk of being claimed). As such, premium allocation for the first five percent of animal loss is substantially greater than for the last five percent of animal loss.

These are merely examples of how the portions of premium 34 may be calculated and distributed in an equal fashion, or an unequal fashion, across a plurality of small insurance companies 26 to render a generally equal or generally unequal capital amounts held within the individual small insurance companies 26, as is desired.

Owners:

More specifically, the owners 36 are the persons or entities that own a small insurance company 26. Due to the limits placed on small insurance companies 26, the ownership is fairly limited to individuals, groups of individuals or simple and small entities.

While the owners 36 own the small insurance company 26, most of the management is handled by the network administrator 22. That is, the owners 36 decide whether to form the small insurance company 26, and whether to enroll the small insurance company 26 into the HLRN 24, and they put up the capital to meet the capital requirements, however, much of the day to day operation and management of the small insurance company 26 is controlled by the network administrator 22. That is, the network administrator 22 allocates the portions or risk 32 and portions of premium 34, retrieves funds to pay claims 46, and prepares reports and audit information, among many other day to day tasks and operations. The owners 36 may choose how funds are invested among the investment options 38 and whether to purchase reinsurance 40.

Investment Options:

More specifically, the investment options 38 are the options selected by the network administrator 22 as available options for investment of the funds held within the small insurance companies 26 during the term of the insurance policies 18 and for so long as funds are retained within the small insurance companies 26. These investment options 38 are reputable, generally sound and proven investments therefor limiting investment to these approved investment options 38 reduces risk and provides financial strength to the HLRN 22. The owners 36 may choose how funds are invested among the investment options 38 or they may take a hands-off approach and allow the network administrator 22 handle this task.

The investment options 38 may include any investable asset such as cash, precious metals, bonds, money market funds, stocks, REITS, real-estate, mutual funds, hedge funds or providing the funds to a money manager to actively manage the funds, or the like.

Reinsurance:

More specifically, reinsurance 40 is insurance provided by a reinsurance company 42 to an insurance company (such as one of the small insurance companies 26 that are part of the HLRN 22), or to the entire HLRN 22. The reinsurance 40 provides coverage to limit losses due to claims 46 submitted by policy holders 12. The reinsurance 40 may be arranged by the network administrator 22 on behalf of the owners 36 of a small insurance company 26, or by the owners 36 themselves.

Reinsurance Company:

More specifically, a reinsurance company 42 is a company that provides reinsurance 40 to a small insurance company 26 or the entire HLRN 22.

Loss:

More specifically, a loss 44 is an injury to person or property, or the loss of property that is measurable and covered by an applicable insurance policy 18 held by a policy holder 12 which leads to a claim 46.

Claim:

More specifically, a claim 46 is a formal demand for compensation for a covered loss 44. A claim 46 is submitted by a policy holder 12 to a fronting insurance company 16 who wrote the insurance policy 18 that provides coverage for the loss 44. When the fronting insurance company 16 receives the claim 46, the fronting insurance company 16 investigates the factual basis for the claim 46, and if verified, the fronting insurance company 16 submits the claim to the network administrator 22 of the HLRN 24 for payment of the claim 46.

Example of Risk Going Into the Horizontally-linked Reinsurance Network:

The following is one example of how risk of loss 20 goes into the system 10 and is distributed among the small insurance companies 26 of the HLRN 24. In this example, the risk owner 12 is a hog producer in central Iowa that has an uncovered risk of loss 20 if some or all of his animals perish due to any one of a great number of diseases, disasters or conditions.

Step 1: The fronting insurance company 16 evaluates the risk of loss 20 and writes an insurance policy 18. The insurance policy 18 defines the covered losses, the ways in which a claim 46 is submitted and paid, how the relationship between the risk owner 12 and the fronting insurance company 16 is to operate, among other contractual information.

The insurance policy 18 may or may not include an express provision where the risk owner 12 consents to the submission of the insurance policy 18 to the HLRN 24. When writing the insurance policy 18, the fronting insurance company 16 may take into account the requirements or guidelines of the HLRN 24 so as to make it easier to submit the insurance policy 18 to the HLRN 24 and to make it more likely that the network administrator 22 will accept the insurance policy 18 into the HLRN 24. The network administrator 22 may provide the advice and consent during the writing of the insurance policy 18 so as to make it easier to submit the insurance policy 18 to the HLRN 24 and to make it more likely that the network administrator 22 will accept the insurance policy 18 into the HLRN 24.

In one arrangement, the insurance policy 18 includes specific information used to efficiently evaluate the insurance policy 18 as well as to distribute portions of risk 32 (and portions of premium 34) among the small insurance companies 26, without violation of the requirements of the applicable laws for small insurance companies 26.

Step 2: The risk owner 12 pays the premium 14 to the fronting insurance company 16 and the fronting insurance company 16 provides the insurance policy 18 to the risk owner 12. This makes the risk owner 12 the policy owner 12 as well. This also transfers the risk of loss 20 specified in the insurance policy 18 to the fronting insurance company 16.

Step 3: The fronting insurance company 16 submits the insurance policy 18 to the network administrator 22 for distribution among the small insurance companies 26 of the HLRN 24.

Step 5: The network administrator 22 evaluates the insurance policy 18 to determine whether it meets the criteria for admission into the HLRN 24. The network administrator 22 may perform this evaluation manually, such as by applying various guidelines, rules of thumb or a high level test. Alternatively, the network administrator 22 may submit the insurance policy 18 to evaluation through the use of algorithm 30. In one arrangement, the algorithm 30 considers the elements of the insurance policy 18 itself in detail (e.g. the amount of premium 14, the risk owner 12, the fronting insurance company 16, the geographic location of the risk of loss 20, the type of risk of loss 20, the likelihood of paying a claim 46, the amount at risk, the term, among countless other elements of the insurance policy 18 itself). In one arrangement, the algorithm 30 considers the elements of the insurance policy 18 in association with the elements of the other insurance policies 18 that are being evaluated for inclusion in the HLRN 24, and/or have already been accepted into the HLRN 24 (e.g. how this particular insurance policy 18 fits with the other insurance policies 18). Based on this analysis, the insurance policy 18 is accepted or denied for inclusion in the HLRN 24. In one arrangement, the network administrator 22 charges an administration fee 28 for merely evaluating the insurance policy 18 for inclusion in the HLRN 24; in other arrangements an administration fee 28 is charged upon acceptance of the insurance policy 18 for inclusion in the HLRN 24.

Step 6a: If the insurance policy 18 is accepted, the network administrator 22 divides the risk of loss 20 among the plurality of small insurance companies 26 of the HLRN 24. In one arrangement, algorithm 30 is used to analyze the insurance policy 18 and slice up the risk of loss 20 of insurance policy 18 and distribute the these portions of risk 32 among one or more small insurance companies 26 of the HLRN 24. In one arrangement, algorithm 30 considers the specific elements of the insurance policy 18 in association with the elements of the other insurance policies 18 which are part of the HLRN 24. Based on this information and consideration, algorithm 30 aims to distribute the portions of risk 32 from insurance policy 18 to various small insurance companies 26 while not violating the requirements of applicable laws for small insurance company 26 to qualify as a small insurance company (such as not exceeding the premiums limitation, not distributing familial risk, etc.). Based on this information and consideration, algorithm 30 aims to distribute the portions of risk 32 from insurance policy 18 to various small insurance companies 26 while diversifying the overall risk profile distributed to the small insurance company 26.

In this example, with insurance policy 18 protecting a hog producer in Iowa against animal mortality, algorithm 30 would aim to distribute this risk among a plurality of small insurance companies 26 while not consolidating a substantial amount of animal mortality risk in any one small insurance company 26, while not consolidating a substantial amount of risk in Iowa in any one small insurance company 26, among many other considerations.

In one arrangement, algorithm 30 aims to create an approximately equal or consistent risk profile within all the small insurance companies 26 that are part of the HLRN 24.

Step 6b: If the insurance policy 18 is accepted, the network administrator 22 divides the premium 14 among the plurality of small insurance companies 26 of the HLRN 24. In one arrangement, all premiums 14 accepted into the HLRN 24 are aggregated and distributed equally among the small insurance companies 26. In another arrangement, like the risk of loss 20, the premium 14 is divided according to the portions of risk 32 by algorithm 30 and these corresponding portions of premium 34 are distributed to the small insurance companies 26. While this latter process may be more tedious, and may lead to different premium totals within the small insurance companies 26, this may lead to a more accurate compensation for the risk that is being assumed by the small insurance companies 26.

Step 7: The network administrator 22 takes an administration fee 28 for distributing the portions of risk 32 (and corresponding portions of premium 34) to the small insurance companies 26.

This is one example of how an insurance policy 18 is submitted, evaluated, and distributed among the HLRN 24. This process is repeated for all the insurance policies 18 submitted to the HLRN 24.

Example of Investment and Reinsurance:

Once aggregate premiums have been allocated to a small insurance company 26, how the funds are to be handled is determined. In one arrangement, the network administrator 22 arranges for various approved and sound investment options 38 to be available for investment of funds held within the small insurance companies 26. These investment options may include any investable asset such as cash, precious metals, bonds, money market funds, stocks, REITS, real-estate, mutual funds, hedge funds or providing the funds to a money manager to actively manage the funds or the like.

In one arrangement, the network administrator 22 allocates the funds among the investment options 38 on behalf of the owner(s) 36 of the small insurance company 26. In another arrangement, the owner(s) 36 of the small insurance company 26 make the investment decisions.

In the event that a claim 46 is submitted, the network administrator 22 may withdraw the needed funds from the small insurance company 26 (which may include liquidating an equivalent amount of assets held within the investment options 38).

Similarly, once the portions of risk 32 have been allocated to a small insurance company 26, reinsurance 40 may be considered to transfer some or all of the risk of loss to another insurer. In one arrangement, the network administrator 22 arranges for various approved reinsurance companies 42 to provide reinsurance 40 to the small insurance company 26.

In one arrangement, the network administrator 22 makes the decision whether and to what extent to purchase reinsurance 40 on behalf of the owner(s) 36 of the small insurance company 26. In another arrangement, the owner(s) 36 of the small insurance company 26 make the decision whether and to what extent to purchase reinsurance 40. In some arrangements, the network administrator 22 may require a minimum amount of reinsurance 40 to be purchased for the small insurance companies 26 as this provides financial stability to the HLRN 24.

Example of a Claim Being Paid:

The following is one example of how a claim 46 goes into the system 10. This example follows the same risk owner 12/policy holder 12 who is a hog producer in central Iowa that purchased an insurance policy 18 to protect against some or all of his animals perishing due to any one of a great number of diseases, disasters or conditions.

Step 1: The policy holder 12 experiences a loss 44 of some of his hogs.

Step 2: The policy holder 12 submits a claim 46 to the fronting insurance company 16 that wrote the insurance policy 18 to the risk owner 12.

Step 3: The fronting insurance company 16 evaluates the claim 46 and determines whether payment is required.

Step 4: If the fronting insurance company 16 determines that the claim 46 is to be paid, the fronting insurance company 16 submits the claim 46 to the network administrator 22.

Step 5: Upon receiving the claim 46, the network administrator 22 evaluates the claim 46.

Step 6: If the network administrator 22 determines that the claim 46 is to be paid, the network administrator 22 determines where the particular portions of risk 32 associated with the insurance policy 18 were distributed among the small insurance companies 26 of the HLRN 24. In one arrangement, algorithm 30 may be used to determine where and to what extend portions of risk 32 were distributed and the amounts payable by each small insurance company 26.

Step 7: Once the network administrator 22 determines where the risk of loss was distributed, the network administrator 22 retrieves the funds from the particular small insurance companies 26. This may require liquidating assets held within the investment options 38 of the small insurance company 26.

Step 7a: If the particular small insurance company 26 has reinsurance 40, the network administrator 22 submits the claim to the reinsurance company 42 for payment.

Step 8: Once funds are retrieved by the network administrator 22, the network administrator 22 transmits the funds to the fronting insurance company 16.

Step 9: Once the fronting insurance company 16 receives the funds, the fronting insurance company transmits the funds to the policy holder 12 thereby making the policy holder 12 whole again.

This process is repeated for all claims 46 submitted to the HLRN 24.

In an alternative arrangement, when a claim is submitted and the fronting insurance company 16 determines that it should be paid, the fronting insurance company 16 pays the claim and then seeks reimbursement (in the herein identified manners) from small insurance companies 26.

Profits:

During the term of the insurance policies 18 submitted to the HLRN 24, and for so long as is statutorily or otherwise required, the portions of premium 34 allocated to the small insurance companies 26 are held within the small insurance companies 26 and/or within their investment options, hopefully earning dividends and capital appreciation.

Once the term has expired and there is no longer any statutory requirement to maintain funds within the small insurance company 26, the difference between the portions of premium 34 received within the small insurance company 26 minus the amount of funds paid out to cover submitted claims 46 is considered profits. However, one of the benefits of being a small insurance company 26 is that so long as these profits are held within the small insurance company 26 they are not taxed.

The owner(s) 36 may determine how to handle these profits or retained earnings. In the event the owner(s) 36 want to maintain the profits within the small insurance company 26, these funds continue to be invested in the available investment options 38, again in hopes of growing through dividends and capital appreciation.

Once the owner(s) 36 decide to remove the funds, the owner(s) pay taxes on these profits as dividends (which is a preferred tax rate). As such, the small insurance company 26 provides substantial tax benefits.

Reports:

Complying with the requirements of being a small insurance company 26 is a complicated matter. As such, in one arrangement, the network administrator 22, with the assistance of algorithm 30, facilitates compliance by generating the needed documents to claim the preferred small insurance company status. This may include providing audits, capital reports, loss reports, payout reports, or any other reports needed.

Limits & Guidelines:

As is shown herein, the network administrator 22 facilitates many, if not most, if not all of the actions required to operate a small insurance company 26. This makes ownership of a small insurance company 26 very appealing.

However, when an owner 36 of a small insurance company 26 submits the small insurance company 26 to the HLRN 24, the owner 36 gives up much of the control of operation of the small insurance company 26. To compensate for this loss of control, the owner(s) 36 can set limits and guidelines for operation of the small insurance company 26. These include, setting any or all of the following: maximum premium intake, maximum risk exposure, capital requirements, reinsurance requirements, diversity requirements, or any other element or limit.

Financial Guarantor:

A credit rating agency (CRA, also called a ratings service) is a company that assigns credit ratings, which rate a debtor's ability to pay back debt and the likelihood of default. A credit rating agency may rate the creditworthiness of issuers of debt obligations, of debt instruments, and in some cases, of the servicers of the underlying debt. There are essentially three credit rating agencies (“The Big Three”). They are Standard & Poor's (“S&P”), Moody's, and Fitch Group. S&P and Moody's are based in the US, while Fitch is dual-headquartered in New York City and London, and is controlled by Hearst. As of 2013 The Big Three hold a collective global market share of roughly 95 percent with Moody's and Standard & Poor's having approximately 40% each and Fitch around 15%. When these credit rating agencies provide a credit rating to a third party entity (such as a small insurance company 16) this provides a quickly and well understood standardized assessment of the rated-entity's ability to meet its financial obligations to other companies (such as fronting insurance company 16). As such, having a credit rating is quite helpful when companies that are evaluating whether to become financially involved with another company.

However, securing a credit rating from one of The Big Three to rate the company's ability to pay back debt is an expensive, time consuming and involved task. From a practical standpoint, securing a credit rating from one of The Big Three is cost-prohibitive for many if not most small entities (such as small insurance companies 16).

While securing a credit rating is cost prohibitive, being un-rated causes a substantial problem as many companies (such as fronting insurance companies 16) refuse to, or are prohibited from, becoming financially involved with (such as investing in or seeding risk through redistribution of a portion or tranche of risk of insurance policy 18) what are known as “un-rated” companies. This is because the investing or seeding company (such as fronting insurance companies 16) is essentially unable to assess the risk associated with the investment or financial involvement.

Applying this to the insurance industry and the system 10 presented herein, insurance companies (such as fronting insurance companies 16) hesitate to seed risk to un-rated insurance companies (such as small insurance companies 26). This is because the insurance company that seeds the risk (fronting insurance companies 16) to the un-rated insurance company (small insurance companies 26) is unable to determine or assess the ability of the un-rated insurance company's ability to pay its obligations should they come due (such as an insurance claim being submitted). Or, said another way, the insurance company that seeds the risk (fronting insurance company 16) does not have easily assessable metrics that help quantify the claims paying ability of the un-rated insurance company (small insurance companies 26). Or, said yet another way, without a credit rating the insurance company that seeds the risk (fronting insurance company 16) does not have an ability to determine the likelihood of the un-rated insurance company (small insurance companies 26) failing to fulfil its financial obligations in the event that a claim comes due.

This presents a substantial problem for fronting insurance companies 16 as it is the fronting insurance company 16 that wrote the insurance policy 18 to the risk owner 12. As such, the fronting insurance company 16 is required to pay a claim to the risk owner 12 when it comes due regardless whether small insurance company 26 fulfills its obligation to pay its portion of the loss (portion of risk 32) to fronting insurance company 16.

When a claim comes due, the fronting insurance company 16 will then look to the small insurance companies 26 that received the portions of risk 32 related to the claim that came due. In the event that the non-rated insurance company (small insurance company 26) fails to pay its obligations, the seeding insurance company (fronting insurance company 16) suffers a direct financial loss. This is because the fronting insurance company 16 wrote the insurance policy 18 and the risk is on the fronting insurance company's 16 books.

It is for this reason that many fronting insurance companies 16 generally hesitate to, or wholly refuse to, seed risk (such as a portion or tranche) of an insurance policy 18 to an un-rated entity (such as a small insurance company 26).

To resolve this problem, in one arrangement a financial guarantor 48 is associated with the insurance system 10. Financial guarantor 48 is any person, entity or organization who guarantees to pay a debt or obligation on behalf of a third-party (who in this case is the small insurance company 26) if that third-party should default on their financial obligation. Financial guarantor 48 essentially acts as a co-signor of sorts, in that they pledge their own assets or services if a situation arises in which the original debtor cannot perform their obligations. Or, said another way, financial guarantor 48 provides insurance or reinsurance to fronting insurance company 16 promising to pay the financial obligations of small insurance company's 26 should small insurance company 26 default on their debts.

By utilizing one or more financial guarantors 48 with the insurance system 10 this essentially provides a credit worthiness rating, or guarantee, that the small insurance companies 26 are capable of paying their portion of an incurred loss. In one manner of speaking, utilizing financial guarantor 48 is credit enhancement that reduces or eliminates credit risk. In another manner of speaking, utilizing financial guarantor 48 is reinsurance for the horizontally linked insurance network 24 and/or small insurance companies 26. Further, utilizing financial guarantor 48 to provide guarantees for some or all of the small insurance companies 26 this essentially creates an investment grade bond.

As such, utilizing one or more financial guarantors 48 to provide financial guarantees for small insurance companies 26 (or the horizontally linked insurance network 24 as a whole) allows fronting insurance companies 16 to seed risk to un-rated small insurance companies 26 without fear of non-payment when a claim comes due. This also allows fronting insurance companies 16, and other institutions, investors or organizations, that are prohibited from investing in or being financially involved with “un-rated” companies to participate in the insurance system 10. Said another way, utilizing financial guarantor 48 to provide financial guarantees for small insurance companies 26 (or the horizontally linked insurance network 24 as a whole) allows fronting insurance companies that are prohibited from seeding risk (or a portion or tranche or risk) associated with insurance policy 18 to “un-rated” entities (such as small insurance companies 26). Financial guarantor 48 is, in a manner of speaking, an insurance provider to small insurance company 26 and/or the horizontally linked insurance network 24 and/or fronting insurance companies 16.

All or some of the small insurance companies 26 that are part of the horizontally linked insurance network 24 may seek a financial guarantee (or a claims paying guarantee) in the form of an insurance policy from financial guarantor 48. In a horizontally linked insurance network 24 where only some of the small insurance companies 26 are backed by financial guarantor 48, network administrator 22 may associate small insurance companies 26 that have the backing of financial guarantor 48 with the fronting insurance companies 16 that require such a backing while associating the small insurance companies 26 that do not have the backing of financial guarantor 48 with those entities that do not require such a backing.

While there is a cost associated with seeking the financial backing of financial guarantor 48, the use of financial guarantor 48 reduces risk of loss and the risk of the insurance system 10 collapsing. As such, the use of financial guarantor 48 reduces the risk associated with participating in the insurance system 10 and therefore in a way reduces the overall cost of participating in the insurance system and helps the participating parties assess their overall exposure and risk.

In one arrangement, financial guarantor 48 provides its endorsement or financial backing or financial guarantee directly to the network administrator 22 for some or all of the small insurance companies 26. In an alternative arrangement, financial guarantor 48 provides its endorsement or financial backing or financial guarantee directly to some or all of the small insurance companies 26 who then provide the proof of financial backing to the network administrator 22 for distribution to potential parties involved with the insurance system 10 such as potential fronting insurance companies 16 who are determining whether to participate in the insurance system 10. In yet another alternative arrangement, financial guarantor 48 provides its endorsement or financial backing or financial guarantee directly to fronting insurance company 16 should it participate in the insurance system 10.

In one arrangement, financial guarantor 48 is itself a rated agency. This credit rating helps fronting insurance companies 16 evaluate the claims paying ability of the financial guarantor 48 in the event that any small insurance company 26 that the financial guarantor 48 provides its financial backing to fails to pay its obligations.

In one arrangement the cost of securing reinsurance or a financial guarantee from financial guarantor 48 is substantially reduced by streamlining the process of securing a financial guarantee from financial guarantor 48 by network administrator 22. That is, in this arrangement, network administrator 22 establishes relationships with one or more financial guarantors 48 (which in one arrangement are rated agencies). When risk comes into the network administrator 22, and is distributed among the small insurance companies 26, the network administrator 22 electronically transmits information regarding the insurance policy 18 to the financial guarantor(s) 48 which is evaluated by the financial guarantor(s) 48. From this information the financial guarantor(s) 48 can determine whether to provide its financial backing to either one or all of the small insurance companies 26, to the horizontally linked insurance network 24 as a whole, or to the fronting insurance company 16. In this way, the relationships and network built by network administrator 22 speeds and eases the process of seeking reinsurance or a financial guarantee from financial guarantor 48 for any one insurance policy 18, portion or tranche of insurance policy 18, or small insurance company 26. This makes administration of the horizontally linked insurance network 24 easier, makes administration of the small insurance companies 26 easier, eliminates the need for the small insurance companies 26 to secure their own financial guarantee from financial guarantor 48, and provides greater uniformity across the insurance system 10, among many other advantages.

Example One—Financial Guarantor Provides Financial Guarantee to Whole Network: In one arrangement, network administrator 22 secures a financial guarantee from one or more financial guarantors 48 for the entire horizontally linked insurance network 24. In this example, when a claim comes due, fronting insurance company 16 submits the claim to network administrator 22. Network administrator 22 then submits the claim for payment by the plurality of small insurance companies 26 that received portions of risk 32 of the subject insurance policy 18. In the event that any one of the small insurance companies 26 fail to pay their obligations or are insolvent, the network administrator 22 submits the unpaid portion of the loss to the financial guarantors 48. When financial guarantors 48 make payment to network administrator 22, network administrator 22 submits the payment to fronting insurance company 16 to make the fronting insurance company 16 whole.

Example Two—Financial Guarantor Provides Financial Guarantee to Small Insurance Companies: In another arrangement, network administrator 22 secures a financial guarantee from one or more financial guarantors 48 for one or all of the small insurance companies 26. In this example, when a claim comes due, fronting insurance company 16 submits the claim to network administrator 22. Network administrator 22 then submits the claim for payment by the plurality of small insurance companies 26 that received portions of risk 32 of the subject insurance policy 18. In the event that any one of the small insurance companies 26 fail to pay their obligations or are insolvent, the network administrator 22 submits the unpaid portion of the loss to the financial guarantors 48. When financial guarantors 48 make payment to network administrator 22, network administrator 22 submits the payment to fronting insurance company 16 to make the fronting insurance company 16 whole.

Example Three—Small Insurance Companies Seek Financial Guarantee from Financial Guarantor: In another arrangement, some or all small insurance companies 26 secure a financial guarantee from one or more financial guarantors 48. The small insurance companies 26 then submit proof of the financial guarantee to the network administrator 22 in order to participate in the insurance system 10. In this example, when a claim comes due, fronting insurance company 16 submits the claim to network administrator 22. Network administrator 22 then submits the claim for payment by the plurality of small insurance companies 26 that received portions of risk 32 of the subject insurance policy 18. In the event that any one of the small insurance companies 26 fail to pay their obligations or are insolvent, the network administrator 22 submits the unpaid portion of the loss to the financial guarantors 48. When financial guarantors 48 make payment to network administrator 22, network administrator 22 submits the payment to fronting insurance company 16 to make the fronting insurance company 16 whole.

These are only some of the countless examples of how a financial guarantee from financial guarantor 48 is utilized in the insurance system 10 presented herein to reduce the risk of loss to fronting insurance companies 16 and to reduce the barriers-to-entry for fronting insurance companies 16 from participating in the insurance system 10.

From the above discussion it will be appreciated that the horizontally-linked reinsurance network presented improves upon the state of the art.

Specifically, the horizontally-linked reinsurance network presented: harnesses the tax benefits available to small insurance companies; diversifies the risk of loss for a small insurance company; links a plurality of small insurance companies together so that they may benefit from size and diversity, while preserving their status as a small insurance company; is easy to administer; is easy to use as a consumer; increases consumer access to unusual or obscure forms of insurance; reduces the administration cost for a small insurance company; reduces the operation cost for a small insurance company; reduces the risk to the consumer that a claim goes unpaid due to the failure of a small insurance company going bankrupt; improves consumer confidence in the use of small insurance companies; spreads the risk of loss across a plurality of small insurance companies; spreads the risk of recovery across a plurality of small insurance companies; makes it easier for new small insurance companies to form and operate; allows for easy payment of claims across a plurality of small insurance companies; creates a new investable asset class never before available that provides preferable tax attributes, appealing returns, and non-correlation to many other asset classes; allows small insurance companies to participate in the benefits of scale and mass; makes owning an insurance company a possibility for persons that would not otherwise be capable of owning an insurance company; allows small insurance companies to operate in a more efficient manner; complies with the spirit and scope of the laws relating to small insurance companies; allows small insurance companies to operate in a more disciplined manner; allows small insurance companies to operate in a more consistent manner; allows a plurality of small insurance companies to take on risk collectively that would exceed the statutory limits placed upon a single small insurance company; makes it more desirable to own and operate a small insurance company; makes it more desirable to use a small insurance company; allows a small insurance company to have a broadly diversified risk portfolio; allows a small insurance company to have a geographically diversified risk portfolio; employs algorithms to diversify the risk among a plurality of small insurance companies; allows for the purchase of reinsurance to limit the risk of loss for any one small insurance company; allows for the investment of insurance premiums; efficiently provides reports and audit information regarding the operation, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. A reinsurance network system, comprising:
a plurality of risk owners;
a plurality of fronting insurance companies;
a network administrator;
a network formed of a plurality of small insurance companies;
wherein the fronting insurance companies write insurance policies to the risk owners to cover against a defined risk;
wherein the fronting insurance companies submit the insurance policies to the network administrator;
wherein the network administrator allocates the risk of the insurance policies among multiple small insurance companies while ensuring that the small insurance companies qualify as a small insurance company under applicable statute.

2. The system of claim 1, wherein the applicable statue includes 26 US Code §831(b).

3. The system of claim 1, wherein the network administrator allocates the risk of the insurance policies among the small insurance companies using an algorithm that incorporates the requirements of 26 US Code §831(b).

4. The system of claim 1, wherein the network administrator allocates the risk among the small insurance companies such that the risk profile within the small insurance companies is approximately uniform.

5. The system of claim 1, wherein when a risk owner with an insurance policy written by a fronting insurance company that was submitted to the network administrator experiences a loss event, the risk owner submits a claim to the fronting insurance company the fronting insurance company verifies the claim and submits the claim to the network administrator, and the network withdraws funds from the small insurance companies who were allocated the corresponding risk.

6. The system of claim 1, further comprising a financial guarantor associated with the system, wherein the financial guarantor provides a financial guarantee that a small insurance company will pay its financial obligations and if the small insurance company does not pay its financial obligations the financial guarantor will pay its financial obligations on behalf of the small insurance company.

7. A method of providing insurance using a network of small insurance companies, the steps comprising:
writing an insurance policy by a fronting insurance company to a risk owner for a defined risk;
paying an insurance premium by the risk owner to the fronting insurance company for an insurance policy;
establishing a network of small insurance companies by a network administrator;
submitting the insurance policy to the network administrator by the fronting insurance company;
allocating the risk of the insurance policy among a plurality of small insurance companies which are a part of the network of small insurance companies while ensuring that the allocation does not disqualify the small insurance company from qualifying as a small insurance company under applicable statute.

8. The method of claim 7, further comprising the steps of:
submitting a claim to the fronting insurance company by the risk owner when a loss is incurred;
submitting a claim to the network administrator by the fronting insurance company when a claim is received from a risk owner;
retrieving funds by the network administrator from the small insurance companies that were allocated the risk.

9. The system of claim 7, further comprising a financial guarantor associated with the system, wherein the financial guarantor provides a financial guarantee that a small insurance company will pay its financial obligations and if the small insurance company does not pay its financial obligations the financial guarantor will pay the financial obligations on behalf of the small insurance company.

10. A reinsurance network system, comprising:
a plurality of risk owners;
a plurality of fronting insurance companies;
a network administrator;
a network formed of a plurality of small insurance companies;
wherein the fronting insurance companies write insurance policies to the plurality of risk owners to cover against a defined risk;
wherein the fronting insurance companies submit the insurance policies to the network administrator;
wherein the network administrator allocates the risk of the insurance policies among multiple small insurance companies in a manner that does not disqualify the small insurance companies from qualifying as a small insurance company under applicable statute.

11. The system of claim 10, wherein the applicable statue includes 26 US Code §831(b).

12. The system of claim 10, wherein the network administrator allocates the risk of the insurance policies among the small insurance companies using an algorithm that incorporates the requirements of 26 US Code §831(b).

13. The system of claim 10, wherein the network administrator aims to allocate the risk among the small insurance companies such that the risk profile within the small insurance companies is approximately uniform.

14. The system of claim 10, wherein when a risk owner with an insurance policy written by a fronting insurance company that was submitted to the network administrator experiences a loss event, the risk owner submits a claim to the fronting insurance company the fronting insurance company verifies the claim and submits the claim to the network administrator, and the network withdraws funds from the small insurance companies who were allocated the corresponding risk.

15. The system of claim 10, further comprising a financial guarantor associated with the system, wherein the financial guarantor provides a financial guarantee that a small insurance company will pay its financial obligations and if the small insurance company does not pay its financial obligations the financial guarantor will pay the financial obligations on behalf of the small insurance company.

16. A reinsurance network, comprising:
a network administrator configured to allocate the risk of a plurality of insurance policies among multiple small insurance companies while ensuring that the small insurance companies qualify as a small insurance company under applicable statute.
